(19) United States
(12) Patent Application Publication
(10) Pub. No.: US 2022/0260218 A1
(43) Pub. Date: Aug. 18, 2022

(54) TEMPORARY RECESSED LIGHTING DEVICE, KIT AND ASSOCIATED METHODS

(71) Applicant: Welby Construction Management, San Diego, CA (US)

(72) Inventor: Edward A. Welby, San Diego, CA (US)

(21) Appl. No.: 17/673,618

(22) Filed: Feb. 16, 2022

Related U.S. Application Data
(60) Provisional application No. 63/150,200, filed on Feb. 17, 2021.

(51) Int. Cl. F21S 8/02; F21V 19/04; F21V 21/008

(52) U.S. Cl. CPC F21S 8/026; F21V 21/008; F21V 19/04

(57) ABSTRACT

A kit, comprising a temporary recessed lighting device for use with a permanent recessed lighting apparatus during construction is provided. The kit includes a lamp holder, which can include a socket configured to receive a lighting element, and at least two electrical leads configured to provide electrical power to the lighting element. The kit includes a first electrical power connector configured to be physically and electrically coupled to the electrical leads of the lamp holder and to a second electrical power connector of the permanent recessed lighting apparatus. The at least two electrical leads can be pig-tail or coaxial leads. The first electrical power connector can include a quick disconnect power connector and can include at least one releasable connection comprising at least one of a threaded connection, a slotted quarter-turn connection, and a clip. The temporary recessed lighting device and a method of utilizing the kit are also provided.

### CROSS-REFERENCE TO RELATED APPLICATIONS

This application claims priority to U.S. Provisional Application No. 63/150,200, filed on Feb. 17, 2021, the entire contents of which is hereby incorporated by reference.

### BACKGROUND

### Field of the Disclosure

The present invention relates generally to temporary recessed lighting device kits and more particularly, to temporary recessed lighting device kits that allows construction professionals to clip a temporary lighting source into the electrically wired recessed lighting housing and/or junction box and provide a temporary light source and related methods involving the same.

### Field of the Disclosure

In building construction, different aspects of the construction process are often completed at different times. For example, after framing a building, an electrician may run electrical wiring throughout the building and, for example, mount and electrically connect recessed lighting housings (e.g., also called cans) at their designated positions in the ceiling(s) of the building. Such recessed lighting housings are each configured to receive a permanent baffle and trim, which is configured to permanently physically and electrically couple with the housing via clips and which also provides a light bulb socket configured to directly receive a light bulb.

In order for these permanent electrical fixtures to function, the permanent baffle and trim, as well as the lightbulb, must first be installed. However, installation of this permanent baffle and trim, as well as installation of the lightbulb into the socket therein, is often completed at a later time, for example, after the walls and ceilings of the building have been at least partially completed (e.g., drywall has been secured to the ceilings).

Accordingly, such conventional permanent recessed lighting fixtures cannot be utilized to provide ambient light within the building in the timeframe between installation of the recessed lighting housing and at least the installation of the drywall, the permanent baffle and trim, since the permanent baffle and trim are designed and specifically configured to mate with the drywall or other at least semi-finished ceiling surface, and the lightbulbs are designed and specifically configured to mate with the lightbulb socket within the permanent baffle and trim.

This can present a problem for construction workers, engineers or other construction professionals who need sufficient lighting within the building to work during this timeframe between installation of the recessed lighting housing and at least the installation of the drywall. Conventionally, during this timeframe, standalone portable lighting sources, such as lighting stands, connected to electrical extension cords are utilized to provide light locally within the building. However, physically moving such standalone portable lighting sources and running electrical extension cords, sometimes long distances, can be cumbersome, time consuming and costly where other time-consuming precautions are taken and/or other mistakes are made.

Accordingly, there is a need for temporary recessed lighting device kits that allows construction professionals to clip a temporary lighting source into the electrically wired recessed lighting housing and/or junction box and provide a temporary light source before the ceiling surfaces are finished and before such permanent recessed lighting baffle & trim and/or permanent recessed light itself are installed.

### SUMMARY

Disclosed herein are temporary recessed lighting devices, kits and associated methods.

According to one aspect, a kit for a temporary recessed lighting device for use with a permanent recessed lighting apparatus during building construction is provided. The kit includes a lamp holder. The lamp holder includes a socket configured to receive a lighting element and at least two electrical leads configured to provide electrical power to the lighting element. The kit includes a first electrical power connector configured to be physically and electrically coupled to the at least two electrical leads of the lamp holder and to a second electrical power connector of the permanent recessed lighting apparatus.

In some embodiments, the kit includes the lighting element. In some embodiments, the lighting element is integral to the lamp holder. In some embodiments, the kit includes instructions describing at least one of how to assemble the temporary recessed lighting device utilizing at least the lamp holder and the first electrical power connector, how to use the temporary recessed lighting device in conjunction with the permanent recessed lighting apparatus, and how to disconnect the temporary recessed lighting device in conjunction with the permanent recessed lighting apparatus. In some embodiments, the at least two electrical leads comprise pig-tail leads. In some embodiments, the at least two electrical leads comprise coaxial leads. In some embodiments, the first electrical power connector comprises a quick disconnect power connector. In some embodiments, the first electrical power connector includes at least one releasable connection including at least one of a threaded connection, a slotted quarter-turn connection, and a clip configured to allow the first electrical power connector to connect to and subsequently disconnect from the second electrical power connector of the permanent recessed lighting apparatus. In some embodiments, the first electrical power connector is physically and electrically pre-coupled to the at least two electrical leads of the lamp holder in the kit. In some embodiments, when the first electrical power connector is physically and electrically coupled to the second electrical power connector of the permanent recessed lighting housing, the electrical leads are configured to simultaneously provide electrical power to the socket of the lamp holder, and physically suspend the lamp holder from the permanent recessed lighting housing.

According to another aspect, a method for using a kit, comprising a temporary recessed lighting device, with a permanent recessed lighting apparatus during construction of a building is provided. The method includes coupling a lighting element to a socket of a lamp holder included within the kit, the lamp holder comprising at least two electrical leads configured to provide electrical power to the lighting element. The method includes electrically and physically coupling a first electrical power connector, included within the kit, to a second electrical power connector of the permanent recessed lighting apparatus. The first electrical power connector is configured for physical and electrical coupling to the at least two electrical leads of the lamp holder.

In some embodiments, the electrically and physically coupling the first electrical power connector to the second electrical power connector of the permanent recessed lighting apparatus is performed after the permanent recessed lighting apparatus is secured to the building and provided electrical power and before a permanent baffle and/or trim of the permanent recessed lighting apparatus is secured to the permanent recessed lighting apparatus. In some embodiments, the first electrical power connector is physically and electrically pre-coupled to the at least two electrical leads of the lamp holder in the kit. In some embodiments, the method further includes physically and electrically coupling the first electrical power connector to the at least two electrical leads of the lamp holder. In some embodiments, upon the electrically and physically coupling the first electrical power connector to the second electrical power connector of the permanent recessed lighting apparatus, the electrical leads of the lamp holder simultaneously provide electrical power to the lighting element, and physically suspend the lamp holder from the permanent recessed lighting apparatus. In some embodiments, the lighting element is included within the kit. In some embodiments, the at least two electrical leads of the lamp holder include pig-tail leads. In some embodiments, the at least two electrical leads of the lamp holder include coaxial leads. In some embodiments, the first electrical power connector comprises a quick disconnect power connector include at least one of a threaded connection, a slotted quarter-turn connection, and a clip configured to allow the first electrical power connector to connect to and subsequently disconnect from the second electrical power connector of the permanent recessed lighting apparatus.

In some embodiments, the temporary recessed lighting device includes the lightbulb. In some embodiments, the at least two electrical leads comprise pig-tail leads. In some embodiments, the first electrical power connector comprises a quick disconnect power connector. In some embodiments, when the first electrical power connector is physically and electrically coupled to the second electrical power connector of the permanent recessed lighting housing, the electrical leads are configured to simultaneously provide electrical power to the socket of the lamp holder, and physically suspend the lamp holder from the permanent recessed lighting housing.

### BRIEF DESCRIPTION OF THE DRAWINGS

The foregoing and other objects and advantages will be appreciated more fully from the following description, with reference to the accompanying drawings. These depicted embodiments are to be understood as illustrative and not as limiting in any way.

FIG. 1 illustrates a temporary recessed lighting device kit, according to some embodiments;

FIG. 2 illustrates insertion of the temporary recessed lighting device from the kit of FIG. 1 into at least a portion of a permanent recessed lighting apparatus, according to some embodiments;

FIG. 3 illustrates another temporary recessed lighting device kit, according to some embodiments;

FIG. 4 illustrates insertion of the temporary recessed lighting device from the kit of FIG. 3 into at least a portion of a permanent recessed lighting apparatus, according to some embodiments;

FIG. 5 illustrates yet another temporary recessed lighting device kit, according to some embodiments;

FIG. 6 illustrates insertion of the temporary recessed lighting device from the kit of FIG. 5 into at least a portion of a permanent recessed lighting apparatus, according to some embodiments; and

FIG. 7 illustrates a junction (or “J”) box configured for permanent electrical connection to wiring of a construction project, according to some embodiments;

FIG. 8 illustrates another junction (or “J”) box configured for permanent electrical connection to wiring of a construction project, according to some embodiments; and

FIG. 9 illustrates a flowchart of a method for using the temporary recessed lighting device from any kit described in this disclosure, according to some embodiments.

### DETAILED DESCRIPTION

To provide an overall understanding of the kits, devices and methods described herein, certain illustrative embodiments will now be described. For the purpose of clarity and illustration, these kits, devices and methods will be described in connection with a permanent recessed lighting housing ultimately configured to permanently house a recessed light and/or with a permanent junction (or “J”) box ultimately configured to power a permanent recessed, flush-mount or wafer-type light (e.g., a permanent 4-6 inch wafer LED light). However, it will be understood by one of ordinary skill in the art that the kits, devices and methods described herein may be adapted and modified as appropriate. These kits, devices and methods may be employed in other suitable applications, such as for other types of permanent lighting fixtures; for application and/or use at one or more times with respect to (e.g., before, during or after) application of one or more construction layers (e.g., ceiling drywall, tape, mud, texture and/or paint) to the ceiling portion of a construction project and such modifications to any embodiment(s) disclosed herein and/or method of use or manufacture will not depart from the scope hereof.

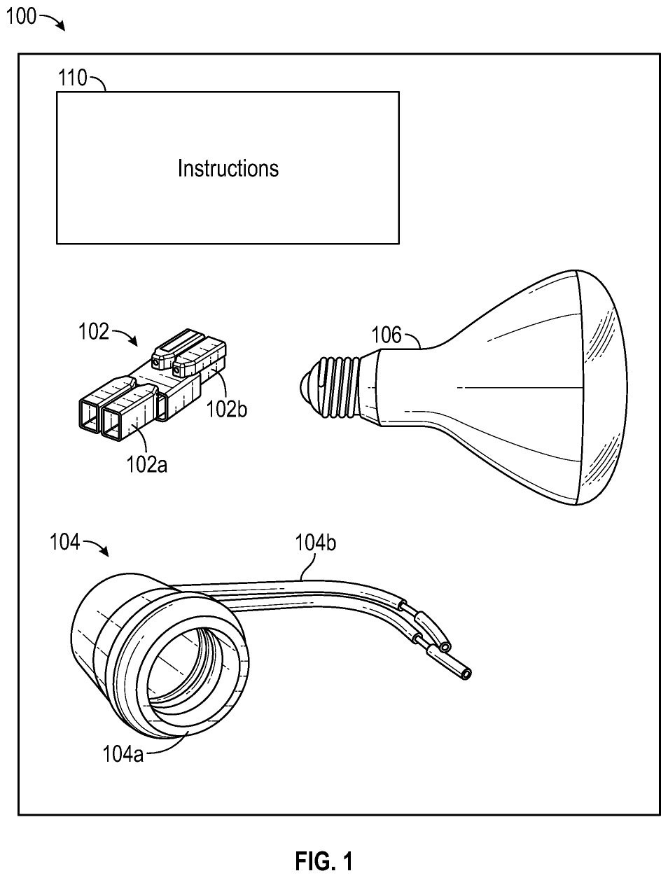

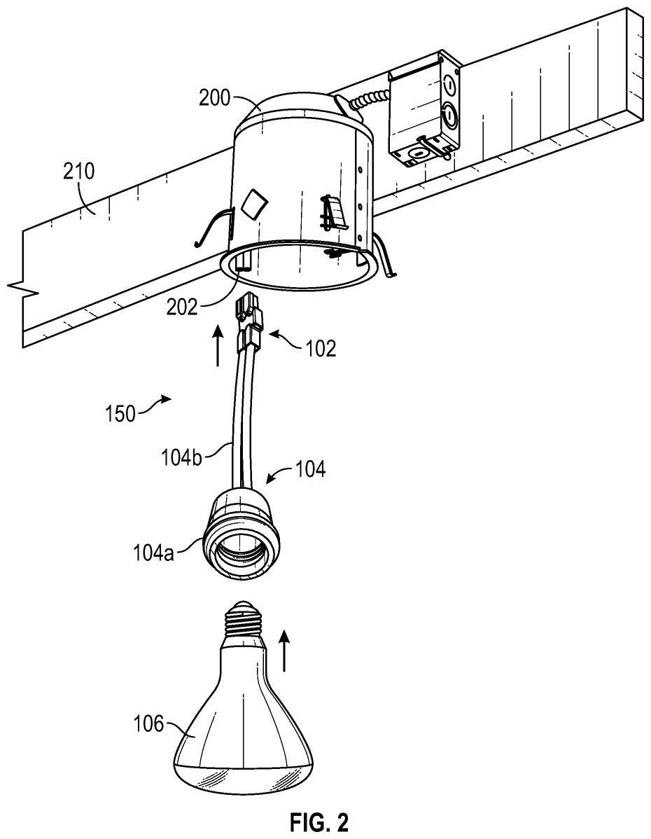

FIG. 1 illustrates a temporary recessed lighting device kit 100, according to some embodiments. In some embodiments, kit 100 includes at least one electrical power connector 102. In some embodiments, power connector 102 may comprise a quick disconnect power connector, such as an Anen™ SA2-10 LED connector or an IdeaI™ 30-682 Power Plug Luminaire Disconnect. In such embodiments, power connector 102 comprises at least one releasable clip configured to allow power connector 102 to connect to, and subsequently disconnect from, another electrical power connector 202 of a permanent recessed lighting housing 200 (see FIG. 2) without damaging either power connector. However, the present disclosure is not so limited and any type of releasable power connector is also contemplated. Accordingly, this disclosure contemplates that power connector 102 may comprise any feature that is even partially visible in any figure of this disclosure. In some embodiments, power connector 102 comprises both a male connector 102a and a female connector 102b, into which male connector 102a is configured to be secured to establish a physical and electrical connection therebetween. Accordingly, each of male connector 102a and female connector 102b comprise at least two electrical terminals. In some other embodiments, power connector 102 comprises only one of male connector 102a or female connector 102b, which may be configured to physically and electrically couple to electrical power connector 202, which is permanently mounted to or otherwise a part of permanent recessed lighting housing 200 (see FIG. 2) and which may have a complementary mating male or female shape compared to the corresponding one of male connector 102a or female connector 102b.

In some embodiments, kit 100 includes a lamp holder 104. In some embodiments, lamp holder 104 comprises a socket 104a configured to receive a lighting element 106, for example, an LED, fluorescent, halogen, incandescent or any other type of lightbulb. In some embodiments, lamp holder 104 comprises at least two leads 104b configured to couple to the terminals of one of male connector 102a or female connector 102b of power connector 102 and, thereby, temporarily deliver electrical power to socket 104a and, so, lighting element 106. In some embodiments, leads 104b can be pig-tail leads. In some embodiments, kit 100 may be provided with leads 104b of lamp holder 104 pre-coupled to the terminals of male connector 102a and/or to the terminals of female connector 102b (e.g., lamp holder 104 and male connector 102a and/or female connector 102b of power connector 102 are packaged in kit 100 as an integral piece). In some other embodiments, kit 100 may be provided with leads 104b of lamp holder 104 that are not pre-coupled to the terminals of male connector 102a and/or to the terminals of female connector 102b (e.g., lamp holder 104 and male connector 102a and/or female connector 102b of power connector 102 are packaged as separate pieces and a user of kit 100 is instructed to manually couple lamp holder 104 and male connector 102a and/or female connector 102b).

In some embodiments, kit 100 includes lighting element 106 configured to be secured into socket 104a of lamp holder 104. Lighting element 106 may be, for example, an LED, fluorescent, halogen, incandescent or any other type of lightbulb. In some embodiments, kit 100 does not include lighting element 106 and a user of kit 100 can supply any compatible lightbulb as desired.

In some embodiments, a temporary recessed lighting device 150 (see also FIG. 2) can comprise lamp holder 104 and at least one of male connector 102a and female connector 102b of power connector 102 connected thereto by leads 104b, as previously described. In some embodiments, temporary recessed lighting device 150 further comprises lighting element 106 or any other lightbulb configured to physically and electrically couple to socket 104a of lamp holder 104, as previously described.

In some embodiments, kit 100 may comprise a set of instructions 110, which may include at least one of: how to assemble temporary recessed lighting device 150 utilizing at least lamp holder 104 and first electrical power connector 102/102a/102b, how to use temporary recessed lighting device 150 in conjunction with permanent recessed lighting housing 200, and how to disconnect temporary recessed lighting device 150 in conjunction with permanent recessed lighting housing 200.

FIG. 2 illustrates insertion of temporary recessed lighting device 150 from kit 100 of FIG. 1 into a permanent recessed lighting housing 200, according to some embodiments. Permanent recessed lighting housing 200 is illustrated as mounted to a beam or joist 210. However, the present disclosure is not so limited and feature 210 may additionally or alternatively be any other suitable portion of a building construction. In some embodiments, permanent recessed lighting housing 200 comprises a metal can and, for example, a junction box for connecting power from a power line to permanent recessed lighting housing 200. However, the present disclosure is not so limited and such a can of permanent recessed lighting housing 200 may comprise any suitable material. In some embodiments, permanent recessed lighting housing 200 comprises a power connector 202, which in some embodiments, has a male or female connector configuration including at least two terminals for providing electrical power to a lightbulb ultimately secured to a permanent baffle and trim (not shown) of permanent recessed lighting housing 200.

In some embodiments, permanent recessed lighting housing 200 is mounted to beam 210 at a time substantially before the ceiling surfaces (e.g., drywall) are secured in place, e.g., against an exposed surface of beam 210. Installation of the permanent baffle and trim (not shown) for permanent recessed lighting housing 200, as well as installation of the lightbulb into a socket within the permanent baffle and trim, cannot occur until after the ceiling material has been secured, since the permanent baffle and trim are designed and specifically configured to physically and electrically mate with permanent recessed lighting housing 200 from the other side of drywall or other at least semi-finished ceiling surface, and lightbulbs are designed and specifically configured to mate with the lightbulb socket within the permanently mounted baffle and trim. Accordingly, permanent recessed lighting housing 200 cannot be utilized as conventionally configured to provide ambient light in the timeframe between installation of permanent recessed lighting housing 200 and at least the installation of the ceiling surface and the permanent baffle and trim.

There has been a long-felt need in at least the construction industry to be able to quickly provide lighting for building construction at least during the timeframe between installation of permanent recessed lighting housing 200 and at least the installation of the ceiling surface and the permanent baffle and trim, without utilizing standalone portable lighting sources, such as lighting stands, or long runs of electrical extension cords. This long-felt need has not previously been solved.

However, kit 100 and temporary recessed lighting device 150 provide a novel and non-obvious solution to the above-mentioned problems in at least the construction industry by allowing construction professionals or other users to take advantage of the electrical power already run to permanent recessed lighting housing 200 to provide lighting at least during the timeframe between installation of permanent recessed lighting housing 200 and installation of at least a ceiling surface and the permanent baffle and trim. Accordingly, utilization of kit 100 and temporary recessed lighting device 150 eliminate the need to use standalone portable lighting sources, such as lighting stands, or long runs of electrical extension cords, while also rendering permanent recessed lighting housing 200 usable during a timeframe and in a condition (e.g., without attachment of the permanent baffle and/or trim) in which it would otherwise remain inoperable.

Moreover, because temporary recessed lighting device 150 is suspended by leads 104b from permanent recessed lighting housing 200 near (e.g., within several inches of) the ceiling (e.g., of an exposed surface of beam 210), the light provided will be substantially unobstructed by construction professionals and equipment within the building, as commonly occurs with the use of portable lighting sources, such as lighting stands, which are supported from the floor and, generally, emanate light from below eye-level.

Lighting element 106 can be secured to socket 104a of lamp holder 104 and power connector 102 can be clipped into mating connector 202 of permanent recessed lighting housing 200 to, thereby, receive power via the electrical wiring already connected to permanent recessed lighting housing 200.

As an added advantage, because there is no electrical switch between power connector 102 and socket 104a, snapping power connector 102 into connector 202 while electrical power is supplied to permanent recessed lighting housing 200 and while lighting element 106 is secured to socket 104a provides immediate feedback to the user as to whether a satisfactory electrical connection has been made, since lighting element 106 will immediately illuminate when a satisfactory electrical connection is made.

In addition, because lighting element 106 and socket 104a are physically suspended from permanent recessed lighting housing 200 by leads 104b, leads 104b are specifically configured and intended to simultaneously provide at least two functions: electrical power supply to lighting element 106 and physical suspension of lighting element 106 from the ceiling, which also helps to reduce part count. This explicit configuration for and intention that leads 104b simultaneously provide physical suspension of lighting element 106 is a feature electrical leads of any other conventional lighting fixture, element and/or socket cannot provide where such lighting fixture, element and/or socket were designed and intended to be secured to the ceiling and/or other surface by any feature other than their electrical leads.

Once the user of temporary recessed lighting device 150 is no longer in need of ambient illumination at the location of permanent recessed lighting housing 200, the user can simply disconnect power connector 102 from mating connector 202 of permanent recessed lighting housing 200 and permanent recessed lighting housing 200 reverts back to its conventional utility. Temporary recessed lighting device 150 can be reused immediately or at a later time, at the same or another location, utilizing the same or another permanent recessed lighting housing 200.

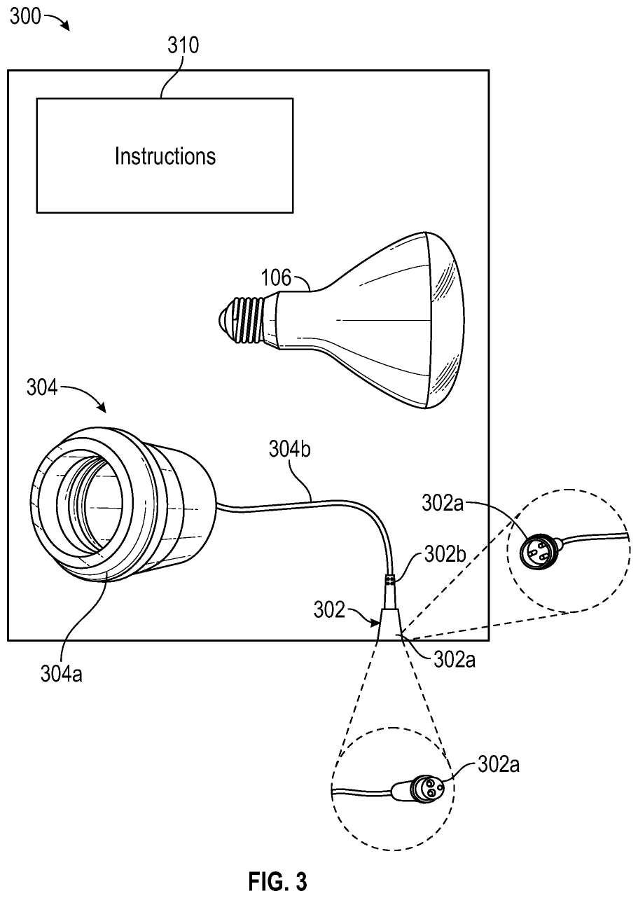

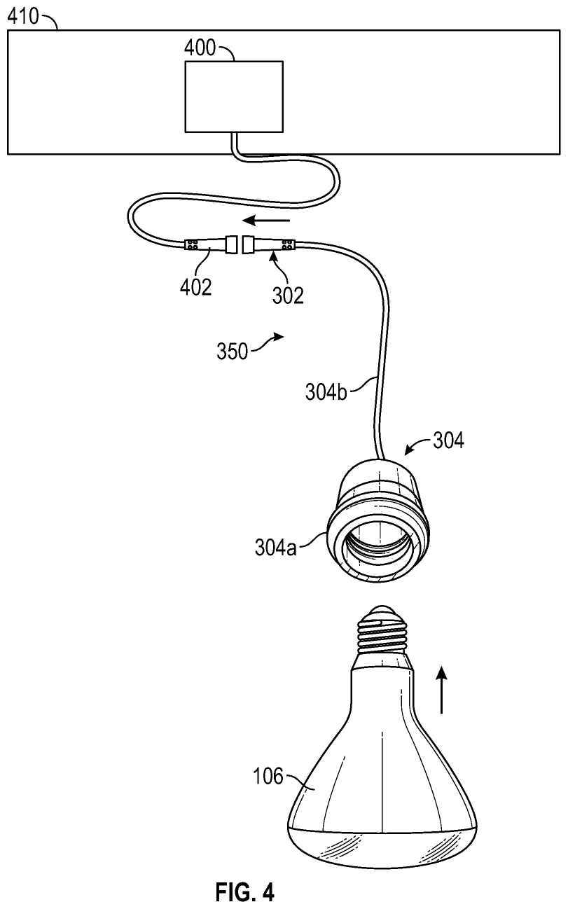

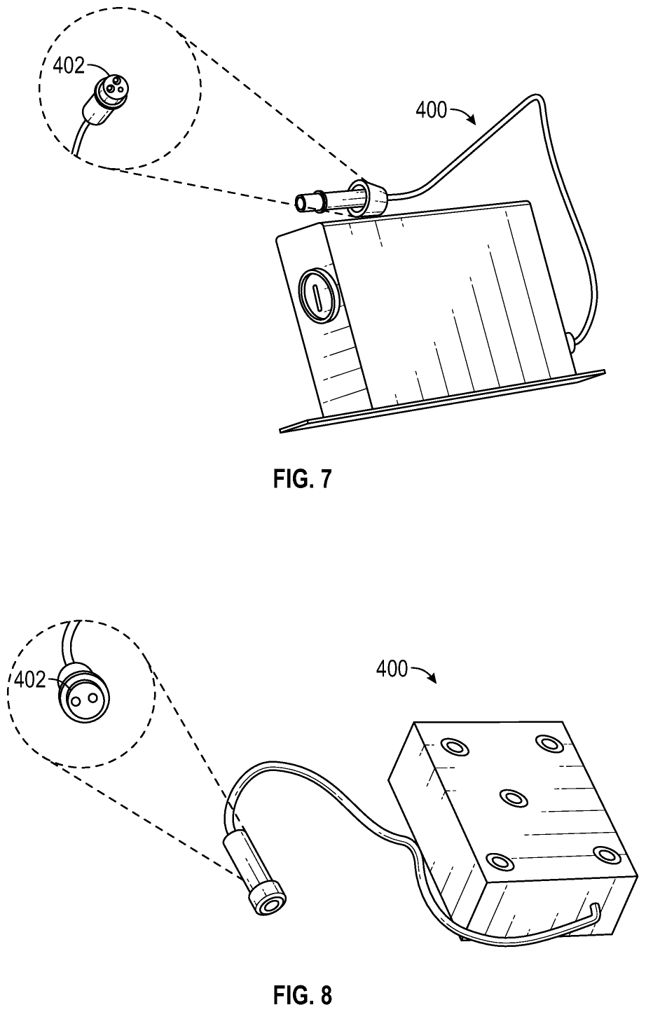

FIG. 3 illustrates another temporary recessed lighting device kit 300, according to some embodiments. In some embodiments, kit 300 includes at least one electrical power connector 302. In some embodiments, power connector 302 may comprise a coaxial power connector. In such embodiments, power connector 302 comprises at least one releasable coupling mechanism (e.g., a threaded connection, a slotted quarter-turn connection or the like) configured to allow power connector 302 to connect to and subsequently disconnect from another electrical power connector 402 of at least a portion of a permanent recessed lighting apparatus 400 (see FIG. 4) without damaging either power connector. However, the present disclosure is not so limited and any type of releasable power connector is also contemplated. In some embodiments, power connector 302 comprises one of a male-type or a female-type coaxial electrical connector 302a. For example, as illustrated in the topmost broken-lined callout of FIG. 3, connector 302a may comprise a female-type connector, e.g., having a recessed central portion within which one or more electrical prongs extend therefrom. As another example, as illustrated in the bottommost broken-lined callout of FIG. 3, connector 302a may comprise a male-type connector, e.g., having a protruding central portion comprising one or more electrical terminals configured to receive a mating electrical prong protruding from a corresponding female-type connector (see e.g., FIG. 8). As illustrated in FIG. 3, electrical connector 302a comprises at least two electrical terminals and/or electrical prongs. Electrical connector 302a is configured to physically and electrically couple to electrical power connector 402, which is permanently mounted to or otherwise a part of permanent recessed lighting apparatus 400 (see FIG. 4) and which may have a complementary mating male or female shape compared to electrical power connector 302a of power connector 302 (see, e.g., FIGS. 7 and 8).

In some embodiments, kit 300 includes a lamp holder 304. In some embodiments, lamp holder 304 comprises a socket 304a configured to receive a lighting element, for example, an LED, fluorescent, halogen, incandescent or any other type of lightbulb. In some embodiments, lamp holder 304 comprises at least two leads 304b configured to couple to the terminals of electrical connector 302a of power connector 302 and thereby temporarily deliver electrical power to socket 304a. In some embodiments, leads 304b can be coaxial leads. In some other embodiments, for example similar to that shown in FIG. 1, leads 304b can be pig-tail leads. In some embodiments, kit 300 may be provided with leads 304b of lamp holder 304 pre-coupled to the terminals of electrical connector 302a (e.g., lamp holder 304 and electrical connector 302a of power connector 302 are packaged in kit 300 as an integral piece). In some other embodiments, kit 300 may be provided with leads 304b of lamp holder 304 not pre-coupled to the terminals of electrical connector 302a (e.g., lamp holder 304 and electrical connector 302a of power connector 302 are packaged as separate pieces and a user of kit 300 manually couples lamp holder 304 and electrical connector 302a).

In some embodiments, kit 300 includes lighting element 106 configured to be secured into socket 304a of lamp holder 304. In some embodiments, kit 300 does not include lighting element 106 and a user of kit 300 can supply a desired lightbulb.

In some embodiments, a temporary recessed lighting device 350 (see also FIG. 4) can comprise lamp holder 304 and at least electrical connector 302a of power connector 302 connected thereto by leads 304b, as previously described. In some embodiments, temporary recessed lighting device 350 further comprises lighting element 106 or any other lightbulb configured to physically and electrically couple to socket 304a of lamp holder 304, as previously described.

In some embodiments, kit 300 may comprise a set of instructions 310 for at least one of how to: assemble temporary recessed lighting device 350 utilizing at least lamp holder 304 and first electrical power connector 302, how to use temporary recessed lighting device 350 in conjunction with at least a portion of the permanent recessed lighting apparatus and/or housing, and how to disconnect temporary recessed lighting device 350 in conjunction with the permanent recessed lighting apparatus and/or housing.

FIG. 4 illustrates insertion of temporary recessed lighting device 350 from kit 300 of FIG. 3 into at least a portion of permanent recessed lighting apparatus 400, according to some embodiments. In some embodiments, portion 400 of the permanent recessed lighting apparatus can comprise a junction (or “J”) box, in some cases, having disposed therein circuitry for converting power from an AC electrical line of a building construction to a suitable AC or DC voltage for powering one or more permanent lighting elements of the permanent recessed lighting apparatus. Portion 400 of the permanent recessed lighting apparatus is illustrated as mounted to a beam 410 or other portion of a building construction. In some embodiments, permanent recessed lighting apparatus 400 comprises a power connector 402, which in some embodiments, has a male or female connector configuration including at least two terminals for providing electrical power to a lighting element ultimately secured to a permanent baffle and trim of permanent recessed lighting apparatus 400 (not shown) and/or to ceiling finish material such as drywall.

In some embodiments, permanent recessed lighting apparatus 400 is mounted to beam 410 at a time substantially before the ceiling surfaces (e.g., drywall) are secured in place. Installation of the permanent baffle and/or trim (not shown) for permanent recessed lighting apparatus 400, as well as installation of the lighting element into the permanent baffle and trim, cannot occur until after the ceiling material has been secured, since the permanent baffle and trim are designed and specifically configured to physically and electrically mate with permanent recessed lighting apparatus 400 from the other side of drywall or other at least semi-finished ceiling surface, and lighting elements are designed and specifically configured to mate with the permanently mounted baffle and trim. Accordingly, permanent recessed lighting apparatus 400 cannot be utilized as conventionally configured to provide ambient light in the timeframe between installation of permanent recessed lighting housing 400 and at least the installation of the ceiling surface and the permanent baffle and trim.

There has been a long-felt need in at least the construction industry to be able to quickly provide lighting for building construction at least during the timeframe between installation of permanent recessed lighting apparatus 400 and at least the installation of the ceiling surface and the permanent baffle and trim, without utilizing standalone portable lighting sources, such as lighting stands, or long runs of electrical extension cords. This long-felt need has not previously been solved.

However, kit 300 and temporary recessed lighting device 350 provide a novel and non-obvious solution to the above-mentioned problems in at least the construction industry by allowing construction professionals or other users to take advantage of the electrical power already run to permanent recessed lighting housing 400 to provide lighting at least during the timeframe between installation of the portion 400 of the permanent recessed lighting apparatus and installation of at least a ceiling surface and the permanent baffle and/or trim. Accordingly, utilization of kit 300 and temporary recessed lighting device 350 eliminate the need to use standalone portable lighting sources, such as lighting stands, or long runs of electrical extension cords, while also rendering permanent recessed lighting apparatus 400 usable during a timeframe and in a condition (e.g., without attachment of the permanent baffle and/or trim) in which it would otherwise remain inoperable.

Moreover, because temporary recessed lighting device 350 is suspended by leads 304b from permanent recessed lighting apparatus 400 near (e.g., within several inches of) the ceiling, the lighting element and light provided thereby will be substantially unobstructed by construction professionals and equipment within the building, as commonly occurs with the use of portable lighting sources, such as lighting stands, which are supported from the floor and, generally, emanate light from below eye level.

Lighting element 106 can be secured to socket 304a of lamp holder 304 and power connector 302 can be secured to mating connector 402 of permanent recessed lighting apparatus 400 to, thereby, receive power via the electrical wiring already connected to permanent recessed lighting apparatus 400.

As an added advantage, because there is no electrical switch between power connector 302 and socket 304a, snapping power connector 302 into connector 402 while electrical power is supplied to permanent recessed lighting apparatus 400 and while lighting element 106 is secured to socket 304a provides immediate feedback to the user as to whether a satisfactory electrical connection has been made, since lighting element 106 will immediately illuminate upon satisfactory electrical connection.

In addition, because lighting element 106 and socket 304a are physically suspended from permanent recessed lighting housing 400 by leads 304b, leads 304b are specifically configured and intended to simultaneously provide at least two functions: electrical power supply to lighting element 106 and physical suspension of lighting element 106 from the ceiling, which also helps to reduce part count. This explicit configuration for and intention that leads 304b simultaneously provide physical suspension of lighting element 106 is a feature electrical leads of any other conventional lighting fixture, element and/or socket cannot provide where such lighting fixture, element and/or socket were designed and intended to be secured to the ceiling and/or other surface by any feature other than their electrical leads.

Once the user of temporary recessed lighting device 350 is no longer in need of ambient illumination at the location of permanent recessed lighting housing 400, the user can simply disconnect power connector 302 from mating connector 402 of permanent recessed lighting apparatus 400 and permanent recessed lighting apparatus 400 reverts back to its conventional utility. Temporary recessed lighting device 350 can be reused immediately or at a later time, at the same or another location utilizing the same or another permanent recessed lighting apparatus 400.

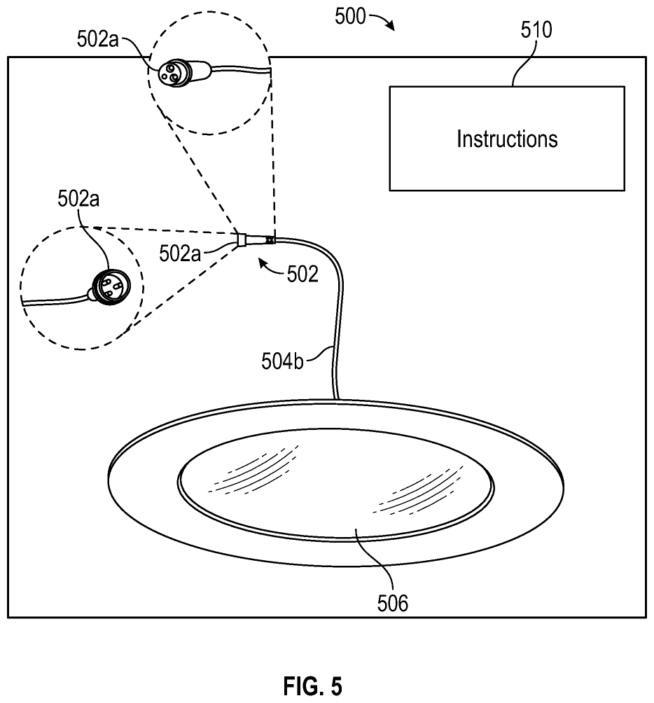

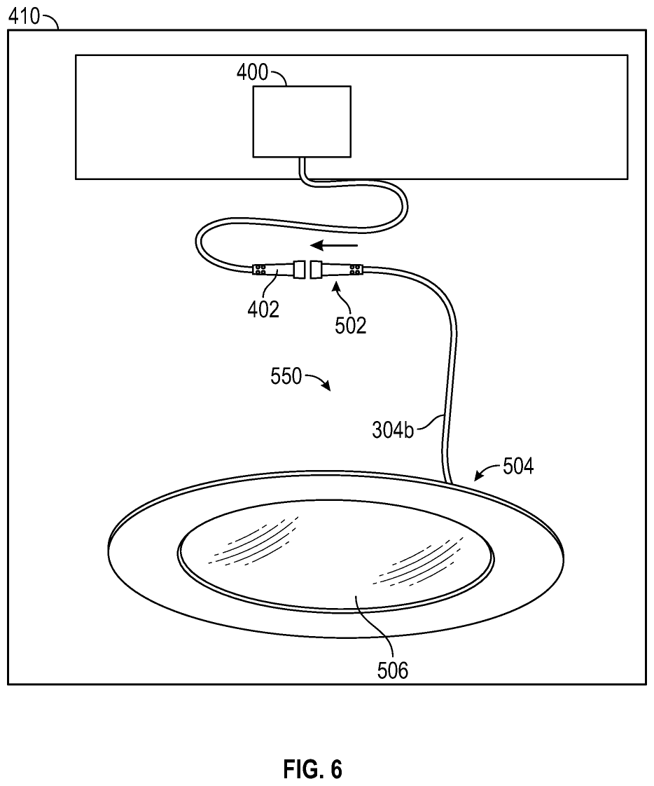

FIG. 5 illustrates yet another temporary recessed lighting device kit 500, according to some embodiments. In some embodiments, kit 500 includes at least one electrical power connector 502. In some embodiments, power connector 502 may comprise a coaxial power connector similar to or the same as that previously described in connection with FIG. 3. In such embodiments, power connector 502 comprises at least one releasable coupling mechanism (e.g., a threaded connection, a slotted quarter-turn connection or the like) configured to allow power connector 502 to connect to and subsequently disconnect from another electrical power connector 402 of at least a portion of a permanent recessed lighting apparatus 400 without damaging either power connector (see FIG. 6). However, the present disclosure is not so limited and any type of releasable power connector is also contemplated. In some embodiments, power connector 502 comprises one of a male-type or a female-type coaxial electrical connector 502a, for example as described for coaxial electrical connector 302a in connection with FIG. 3. In some embodiments, electrical connector 502a comprises at least two electrical terminals. Electrical connector 502a is configured to physically and electrically couple to electrical power connector 402, which is permanently mounted to or otherwise a part of permanent recessed lighting apparatus 400 (see FIG. 6) and which may have a complementary mating male or female shape compared to electrical power connector 502a of power connector 502.

In some embodiments, kit 500 includes a lamp holder 504 comprising an integrated lighting element 506, for example, an LED or LED wafer, fluorescent, halogen, incandescent or any other type of lighting element. In some embodiments, lamp holder 504 comprises at least two leads 504b configured to couple to the terminals of electrical connector 502a of power connector 502 and thereby temporarily deliver electrical power to lighting element 506. In some embodiments, leads 504b can be coaxial leads. In some other embodiments, for example similar to that shown in FIG. 1, leads 504b can be pig-tail leads. In some embodiments, kit 500 may be provided with leads 504b of lamp holder 504 pre-coupled to the terminals of electrical connector 502a (e.g., lamp holder 504 and electrical connector 502a of power connector 502 are packaged in kit 500 as an integral piece).

In some embodiments, a temporary recessed lighting device 550 (see FIG. 6) can comprise lamp holder 504 and at least electrical connector 502a of power connector 502 connected thereto by leads 504b, as previously described. As previously described above, lamp holder 504 comprises integral lighting element 506.

In some embodiments, kit 500 may comprise a set of instructions 510 for at least one of: how to assemble temporary recessed lighting device 550 utilizing at least lamp holder 504 and first electrical power connector 502, how to use temporary recessed lighting device 550 in conjunction with at least a portion of the permanent recessed lighting apparatus and/or housing, and how to disconnect temporary recessed lighting device 550 in conjunction with the permanent recessed lighting apparatus and/or housing.

FIG. 6 illustrates insertion of temporary recessed lighting device 550 from kit 500 of FIG. 5 into at least a portion of permanent recessed lighting apparatus 400, according to some embodiments. In some embodiments, portion 400 of the permanent recessed lighting apparatus can comprise a junction box, in some cases, having disposed therein circuitry for converting power from an AC electrical line of a building construction to a suitable AC or DC voltage for powering one or more permanent lighting elements of the permanent recessed lighting apparatus. Portion 400 of the permanent recessed lighting apparatus is illustrated as mounted to a beam 410 or other portion of a building construction. In some embodiments, permanent recessed lighting apparatus 400 comprises a power connector 402, which in some embodiments, has a male or female connector configuration including at least two terminals for providing electrical power to a lighting element ultimately secured to a permanent baffle and trim (not shown) of permanent recessed lighting apparatus 400.

In some embodiments, permanent recessed lighting apparatus 400 is mounted to beam 410 at a time substantially before the ceiling surfaces (e.g., drywall) are secured in place. Installation of the permanent baffle and trim (not shown) for permanent recessed lighting apparatus 400, as well as installation of the lighting element into the permanent baffle and trim, cannot occur until after the ceiling material has been secured, since the permanent baffle and trim are designed and specifically configured to physically and electrically mate with permanent recessed lighting apparatus 400 from the other side of drywall or other at least semi-finished ceiling surface, and lighting elements are designed and specifically configured to mate with the permanently mounted baffle and trim. Accordingly, permanent recessed lighting apparatus 400 cannot be utilized as conventionally configured to provide ambient light in the timeframe between installation of permanent recessed lighting housing 400 and at least the installation of the ceiling surface and the permanent baffle and trim.

There has been a long-felt need in at least the construction industry to be able to quickly provide lighting for building construction at least during the timeframe between installation of permanent recessed lighting apparatus 400 and at least the installation of the ceiling surface and the permanent baffle and trim, without utilizing standalone portable lighting sources, such as lighting stands, or long runs of electrical extension cords. This long-felt need has not previously been solved.

However, kit 500 and temporary recessed lighting device 550 provide a novel and non-obvious solution to the above-mentioned problems in at least the construction industry by allowing construction professionals or other users to take advantage of the electrical power already run to permanent recessed lighting housing 400 to provide lighting at least during the timeframe between installation of permanent recessed lighting apparatus 400 and installation of at least a ceiling surface and the permanent baffle and trim. Accordingly, utilization of kit 500 and temporary recessed lighting device 550 eliminate the need to use standalone portable lighting sources, such as lighting stands, or long runs of electrical extension cords, while also rendering permanent recessed lighting apparatus 400 usable during a timeframe and in a condition (e.g., without attachment of the permanent baffle and/or trim) in which it would otherwise remain inoperable.

Moreover, because temporary recessed lighting device 550 is suspended by leads 504b from permanent recessed lighting apparatus 400 near (e.g., within several inches of) the ceiling, the lighting element and light provided thereby will be substantially unobstructed by construction professionals and equipment within the building, as commonly occurs with the use of portable lighting sources, such as lighting stands, which are often supported from the floor and emanate light from below eye level.

As an added advantage, because there is no electrical switch between power connector 502 and lighting element 506, snapping power connector 502 into connector 402 while electrical power is supplied to permanent recessed lighting apparatus 400 provides immediate feedback to the user as to whether a satisfactory electrical connection has been made, since lighting element 506 will immediately illuminate.

In addition, because lighting element 506 is physically suspended from permanent recessed lighting apparatus 400 by leads 504b, leads 504b are specifically configured and intended to simultaneously provide at least two functions: electrical power supply to lighting element 506 and physical suspension of lighting element 506 from the ceiling, which also helps to reduce part count. This explicit configuration for and intention that leads 504b simultaneously provide physical suspension of lighting element 506 is a feature electrical leads of any other conventional lighting fixture, element and/or socket cannot provide where such lighting fixture, element and/or socket were designed and intended to be secured to the ceiling and/or other surface by any feature other than their electrical leads.

Once the user of temporary recessed lighting device 550 is no longer in need of ambient illumination at the location of permanent recessed lighting apparatus 400, the user can simply disconnect power connector 502 from mating connector 402 of permanent recessed lighting apparatus 400 and permanent recessed lighting apparatus 400 reverts back to its conventional utility. Temporary recessed lighting device 550 can be reused immediately or at a later time, at the same or another location utilizing the same or another permanent recessed lighting apparatus 400.

The present disclosure is not limited to utilization only before ceiling materials are hung. In some embodiments, one or more of temporary recessed lighting device 150, 350, 550 from any of kits 100, 300, 500 of any of FIGS. 1, 3 and 5 may also or alternatively be utilized after at least a portion of the ceiling is at least semi-finished. For example, in the construction industry, there are situations in which a subcontractor performs aspects of the work once the ceilings have already been at least semi-finished correctly by a different subcontractor, since mistakes made at a later stage can be more costly when more work must be redone. Accordingly, any embodiment described herein may also be utilized after at least a portion of the ceiling is at least semi-finished.

FIG. 7 illustrates an example embodiment of a junction (or “J”) box configured for permanent electrical connection to wiring of a construction project, according to some embodiments. In some embodiments, the J box shown in FIG. 7 may be the portion of permanent recessed lighting apparatus 400 shown in FIGS. 4 and/or 6. The J box in FIG. 7 is illustrated as having a coaxial cable coupled to a male-type connector 402, e.g., having a protruding central portion comprising one or more electrical terminals configured to receive a mating electrical prong protruding from a corresponding female-type connector.

FIG. 8 illustrates another example embodiment of a junction (or “J”) box configured for permanent electrical connection to wiring of a construction project, according to some embodiments. In some embodiments, the J box shown in FIG. 8 may be the portion of permanent recessed lighting apparatus 400 shown in FIGS. 4 and/or 6. The J box in FIG. 8 is illustrated as having a coaxial cable coupled to a female-type connector, e.g., having a recessed central portion within which one or more electrical prongs extend therefrom, the prongs being configured to be received by mating electrical terminals of a corresponding male-type connector.

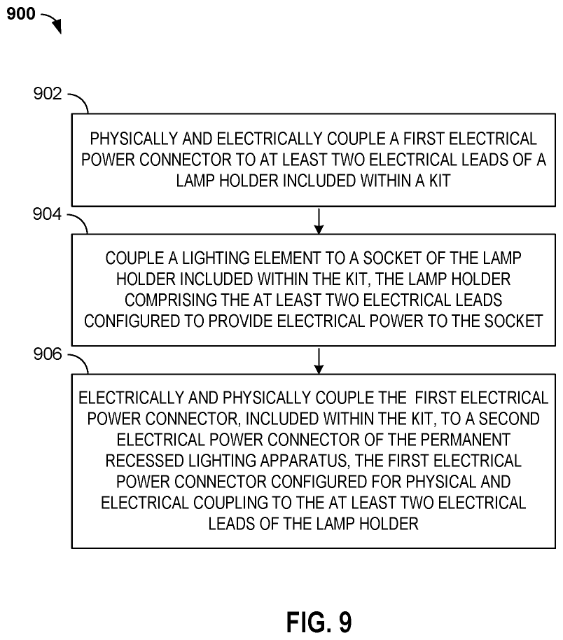

FIG. 9 illustrates a flowchart 900 of a method for using temporary recessed lighting device 150, 350, 550 from any of kits 100, 300, 500 of any of FIGS. 1, 3 and 5, according to some embodiments. In some embodiments, such a method may be carried out during building construction, for example, at least during the timeframe between installation of at least a portion of permanent recessed lighting apparatuses 200, 400 and installation of at least the ceiling surface and/or the permanent baffle and trim. In some other embodiments, such a method may be carried out during building construction in the timeframe after installation of at least a portion of permanent recessed lighting apparatuses 200, 400 and installation of at least a portion of the ceiling surface, e.g., the drywall.

In some embodiments, electrical power connector 102, 302, 502 is physically and electrically pre-coupled to leads 104b, 304b, 504b of lamp holder 104, 304, 504 in kit 100, 300, 500. In such embodiments, block 902 can be omitted and flowchart 900 could alternatively start with block 904.

At block 902, a user physically and electrically couples electrical power connector 102, 302, 502 to leads 104b, 304b, 504b of lamp holder 104, 304, 504. In some embodiments, both power connector 102, 302, 502 and lamp holder 104, 304, 504 are included in kit 100. In some embodiments, leads 104b, 304b of lamp holder 104, 304 comprise pig-tail leads. In some embodiments, leads 304b, 504b of lamp holder 304, 504 comprise coaxial leads. In some embodiments, lighting element 506 is physically and electrically pre-coupled to (i.e., integral to) lamp holder 504. In such embodiments, block 904 can also be omitted and flowchart 900 could alternatively start with block 906.

At block 904, the user couples a lighting element (e.g., lighting element 106) to lamp holder 104, 304 included within kit 100, 300. As described above, lamp holder 104, 304 comprises at least two electrical leads 104b, 304b configured to provide electrical power to socket 104a, 304a. In some embodiments, lighting element 106 is included in kit 100, 300.

At block 906, the user electrically and physically couples power connector 102, 302, 502, included within kit 100, 300, 500 to power connector 202, 402, 402 of permanent recessed lighting apparatus 200, 400. As previously described, power connector 102, 302, 502 is configured for physical and electrical coupling to leads 104b, 304b, 504b of lamp holder 104, 304, 504. Accordingly, power connector 102, 302, 502 is either physically and electrically pre-coupled to leads 104b, 304b, 5043b of lamp holder 104, 304, 504 in kit 100, 300, 500 or, as described above for block 902, physically and electrically coupled to leads 104b, 304b of lamp holder 104, 304 by the user of kit 100, 300. In some embodiments, one or both of power connector 102 and power connector 202 comprise at least one releasable clip configured to allow connection and subsequent disconnection between power connector 102 and power connector 202 of permanent recessed lighting housing 200. In some embodiments, one or both of power connector 302, 502 and respective power connector 402, 402 comprises at least one releasable coupling mechanism (e.g., a threaded connection, a slotted quarter-turn connection or the like) configured to allow connection and subsequent disconnection between power connector 302, 502 and respective power connector 402, 402 of permanent recessed lighting apparatus 400.

In some embodiments, electrically and physically coupling power connector 102, 302, 502 to power connector 202, 402, 402 of permanent recessed lighting housing 200, 400 is performed after permanent recessed lighting housing 200, 400 is secured to the building (e.g., beam 210, 410 of respective FIGS. 2, 4, 6) and provided electrical power and before drywall and/or a permanent baffle and/or trim (not shown) of the permanent recessed lighting housing is secured in place.

In some embodiments, electrically and physically coupling power connector 102, 302, 502 to power connector 202, 402 of permanent recessed lighting housing 200, 400 is performed after permanent recessed lighting housing 200, 400 is secured to the building (e.g., beam 210, 410, 410 of respective FIGS. 2, 4, 6) and provided electrical power but after drywall (not shown) is secured in place.

In some embodiments, upon electrically and physically coupling power connector 102, 302, 502 to power connector 202, 402, 402 of permanent recessed lighting apparatus 200, 400, leads 104b, 304b, 504b of lamp holder 104, 304, 504 simultaneously provide electrical power to socket 104a, 304a, 504a of lamp holder 104, 304, 504 (as well as to lighting element 106, 506 physically and electrically coupled thereto), and physically suspend lamp holder 104, 304, 504 from at least the portion of permanent recessed lighting apparatus 200, 400.

It is to be understood that the foregoing is merely illustrative and is not to be limited to the details given herein. While several embodiments have been provided by the present disclosure, it should be understood that the disclosed kits, devices and methods, and their components, may be embodied in any other specific forms without departing from the scope of the disclosure.

Variations and modifications will occur to those of skill in the art after reviewing this disclosure, where disclosed features may be implemented in any combination and sub-combinations (including multiple dependent combinations and sub-combinations), with one or more other features described herein. The various features described or illustrated above, including any components thereof, may be combined or integrated in other devices, systems, or methods; moreover, certain features may be omitted or not implemented.

Examples of changes, substitutions and alternations are ascertainable by one skilled in the art and to be made without departing from the scope of the information disclosed herein. All references cited herein are incorporated by reference in their entirety and made part of this application.

What is claimed is:

1. A kit for a temporary recessed lighting device for use with a permanent recessed lighting apparatus during building construction, the kit comprising:
a lamp holder comprising:
a socket configured to receive a lighting element, and
at least two electrical leads configured to provide electrical power to the lighting element; and
a first electrical power connector configured to be physically and electrically coupled to the at least two electrical leads of the lamp holder and to a second electrical power connector of the permanent recessed lighting apparatus.

2. The kit of claim 1, further comprising the lighting element.

3. The kit of claim 2, wherein the lighting element is integral to the lamp holder.

4. The kit of claim 1, further comprising instructions describing at least one of:
how to assemble the temporary recessed lighting device utilizing at least the lamp holder and the first electrical power connector;
how to use the temporary recessed lighting device in conjunction with the permanent recessed lighting apparatus; and
how to disconnect the temporary recessed lighting device in conjunction with the permanent recessed lighting apparatus.

5. The kit of claim 1, wherein the at least two electrical leads comprise pig-tail leads.

6. The kit of claim 1, wherein the at least two electrical leads comprise coaxial leads.

7. The kit of claim 1, wherein the first electrical power connector comprises a quick disconnect power connector.

8. The kit of claim 1, wherein the first electrical power connector comprises at least one releasable connection comprising at least one of a threaded connection, a slotted quarter-turn connection, and a clip configured to allow the first electrical power connector to connect to and subsequently disconnect from the second electrical power connector of the permanent recessed lighting apparatus.

9. The kit of claim 1, wherein the first electrical power connector is physically and electrically pre-coupled to the at least two electrical leads of the lamp holder in the kit.

10. The kit of claim 1, wherein, when the first electrical power connector is physically and electrically coupled to the second electrical power connector of the permanent recessed lighting apparatus, the electrical leads are configured to simultaneously:
provide electrical power to the lamp holder; and
physically suspend the lamp holder from the permanent recessed lighting apparatus.

11. A method for using a kit, comprising a temporary recessed lighting device, with a permanent recessed lighting apparatus during construction of a building, the method comprising:
coupling a lighting element to a lamp holder included within the kit, the lamp holder comprising at least two electrical leads configured to provide electrical power to the lighting element; and
electrically and physically coupling a first electrical power connector, included within the kit, to a second electrical power connector of the permanent recessed lighting apparatus, the first electrical power connector configured for physical and electrical coupling to the at least two electrical leads of the lamp holder.

12. The method of claim 11, wherein the electrically and physically coupling the first electrical power connector to the second electrical power connector of the permanent recessed lighting apparatus is performed after at least a portion of the permanent recessed lighting apparatus is secured to the building and provided electrical power and before a permanent baffle and/or trim of the permanent recessed lighting apparatus is secured to the permanent recessed lighting housing.

13. The method of claim 11, wherein the electrically and physically coupling the first electrical power connector to the second electrical power connector of the permanent recessed lighting apparatus is performed after at least a portion of the permanent recessed lighting apparatus is secured to the building and provided electrical power and after at least a portion of a ceiling is disposed over the portion of the permanent recessed lighting apparatus.

14. The method of claim 11, further comprising physically and electrically coupling the first electrical power connector to the at least two electrical leads of the lamp holder.

15. The method of claim 11, wherein, upon the electrically and physically coupling the first electrical power connector to the second electrical power connector of the permanent recessed lighting housing, the electrical leads of the lamp holder simultaneously:
provide electrical power to the lighting element; and
physically suspend the lamp holder from the permanent recessed lighting apparatus.

16. The method of claim 11, wherein the lighting element is included within the kit.

17. The method of claim 11, wherein the lighting element is integral to the lamp holder.

18. The method of claim 11, wherein the at least two electrical leads of the lamp holder comprise at least one of:
pig-tail leads; and
coaxial leads.

19. The method of claim 11, wherein the first electrical power connector comprises a quick disconnect power connector.

20. The method of claim 11, wherein the first electrical power connector comprises at least one releasable connection comprising at least one of a threaded connection, a slotted quarter-turn connection, and a clip configured to allow the first electrical power connector to connect to and subsequently disconnect from the second electrical power connector of the permanent recessed lighting apparatus.
